(19) United States
(12) Patent Application Publication
(10) Pub. No.: US 2005/0216738 A1
(43) Pub. Date: Sep. 29, 2005

(54) Radio transmission device, mutual authentication method and mutual authentication program

(75) Inventors: Yoshikazu Kita, Osaka (JP); Yoshikazu Mihara, Kawanishi-shi (JP)

Correspondence Address: McDermott Will & Emery LLP, 600 13th Street, N.W., Washington, DC, 20005-3096, US

(73) Assignee: Sanyo Electric Co., Ltd.

(21) Appl. No.: 11/090,032

(22) Filed: Mar. 28, 2005

(30) Foreign Application Priority Data
Mar. 29, 2004 (JP) 2004-096170
Feb. 25, 2005 (JP) 2005-051052

(51) Int. Cl. H04L 9/00

(52) U.S. Cl. 713/168

(57) ABSTRACT

A user operates a remote control to enter an authentication code shared by a plurality of radio transmission devices performing radio transmission. Remote control transmission/reception unit 1 converts an infrared signal received from the remote control to an electric signal, and extracts the authentication code from the electric signal. The authentication code is recorded on an authentication code record region in a nonvolatile storage region. In an authentication communication mode, a radio unit encrypts a radio unit MAC address with the authentication code used as a key, and transmits it. Further, the radio unit decrypts the radio unit MAC address returned from the radio transmission device of the opposite party of the transmission with the authentication code used as the key. The radio transmission device obtains the radio unit MAC address of the opposite party of the transmission, and ends the authentication mode.

### BACKGROUND OF THE INVENTION

1. Field of the Invention

The present invention relates to a radio transmission device, a mutual authentication method and a mutual authentication program, and more particularly to a radio transmission device performing mutual authentication when performing radio transmission of data signals as well as a mutual authentication method and a mutual authentication program executed by such a radio transmission device.

2. Description of the Background Art

In recent years, large attention has been given to a field of home networks, and technologies for establishing radio home networks have been actively developed. As an example of such technologies, there has been developed a radio transmission device, which couples a home-use electric appliance and a computer by radio in a space of a limited area such as a home or office. For example, there has been developed a radio transmission device, which couples by radio an AV data reproducing device such as a video tape recorder or a DVD (Digital Versatile Disk) player reproducing video and audio signals (which may be collectively referred to as “AV data” hereinafter) to an AV data display device such as a television set or a projector.

FIG. 13 schematically shows an example of a manner of use of a radio transmission device.

Referring to FIG. 13, AV data display devices 40a-40c such as television sets are arranged on respective floors of a home 50. On the first floor, an AV data reproducing device 30a such as a video tape recorder, which is connected to an AV data display device 40a, is arranged on the first floor. AV data reproducing device 30a and AV data display devices 40b and 40c are connected to radio transmission devices 60a, 60c and 60c, respectively.

When the above structure operates in a normal communication mode, the AV data reproduced by AV data reproducing device 30a arranged on the first floor is transmitted via a cable, and is also converted by radio transmission device 60a into radio signals, which are transmitted to radio transmission devices 60b and 60c arranged on the second and third floors, respectively.

Radio transmission devices 60b and 60c receive the radio signals thus transmitted, and convert these signals into the original AV data, and AV data display devices 40b and 40c output the AV data thus converted.

For correctly coupling the AV data signal reproducing device and the AV data display device desired by a user, as shown in FIG. 13, mutual authentication must be performed between radio transmission devices arranged for the respective devices prior to the radio transmission. This is because the radio-transmitted AV data may be received by an indefinite number of radio transmission devices such as a radio transmission device in another home, in contrast to the wire-transmission.

Technologies of the mutual authentication operation have already been developed for use in a technical field of a radio LAN (Local Area Network), which is employed for data transmission and others between terminal devices of personal computers or the like, and an example thereof has been disclosed Japanese Patent Laying-Open No. 04-205453.

FIG. 14 illustrates a configuration of a mutual authentication method disclosed in Japanese Patent Laying-Open No. 04-205453.

Referring to FIG. 14, an information carrier 100 such as an IC card device and an information processing device 110 for center control executes mutual authentication for authenticating each other before information communication.

More specifically, information carrier 100 transmits individual data ID, which is prestored in a first storing unit 101, by a first transmitting unit 108 to information processing device 110, i.e., an opposite party of communication. Individual data ID is peculiar to each individual information carrier, and is managed by information processing device 110.

In information processing device 110, a data processing unit 112 produces a master key km peculiar to each information carrier from received individual data ID and a center key stored in a third storing unit 111. Thus, one master key km is produced corresponding to one individual data ID. A second storing unit 102 of information carrier 100 prestores this master key km.

Information processing device 110 further produces a session key ks by a key producing unit 116 in a random fashion. A second encrypting unit 113 encrypts session key ks with master key km provided from data processing unit 112. A second transmitting unit 118 transmits encrypted data Ekm[ks] to information carrier 100.

Information carrier 100 receives encrypted data Ekm[ks], and decrypts it by first decrypting unit 103 with master key km stored in second storing unit 102.

Further, session key ks, which is the data obtained by decryption, is transferred to a first encrypting unit 105. First encrypting unit 105 encrypts coupling data provided from a coupling unit 104 with session key ks. First transmitting unit 108 transmits coupled data Eks[R∥D] thus encrypted to information processing device 110. Coupled data Eks[R∥ID] is formed by sequential coupling of individual data ID stored in first storing unit 101 and a random number R produced by a random number producing unit 106.

Information processing device 110 decrypts coupled data Eks[R∥D] by a second decrypting unit 115 with session key ks. From encrypted data R∥D, a separating unit 114 produces a random number R′ and individual data ID′ separated from each other.

A second comparing unit 117 compares individual data ID′ with initially received individual data ID for checking information carrier 100. When mismatching occurs between these data, it is assumed that a certain fraud occurred, and information carrier 100 is rejected.

In information carrier 100, a first comparing unit 107 compares received random number R′ with random number R produced by random number producing unit 106 to check information processing device 110. When mismatching occurs between these numbers, it is assumed that a certain fraud occurred, and information processing device 110 is rejected.

Only after the opposite parties are mutually authenticated by the foregoing operations, information communication can be performed between them. The subsequent communication is performed with session key ks.

In a conventional mutual authentication method, an information processing device produces a master key and a session key, and information encrypted with these keys is transmitted between information carriers so that high security can be ensured.

However, each device must perform complicated and sophisticated processing in a complicated encryption method, and this makes it difficult to apply the conventional method to radio home networks, which can be expected to come rapidly into widespread use.

For increasing general versatility of the radio transmission devices, therefore, it is necessary to provide a simple mutual authentication method ensuring high security.

### SUMMARY OF THE INVENTION

An object of the invention is to provide a radio transmission device, a mutual authentication method and a mutual authentication program, which can perform mutual authentication with high concealability by a simple structure.

According to an aspect of the invention, a radio transmission device for transmitting a data signal by radio, includes a mutual authentication unit for performing mutual authentication of opposite parties between the radio transmission devices performing radio transmission; and a radio transmitting unit for transmitting the data signal by radio between the authenticated radio transmission devices. The mutual authentication unit includes a remote control signal receiving unit for receiving an infrared signal emitted from a remote control, converting the infrared signal to an electric signal and extracting an authentication code shared by the radio transmission devices performing the radio transmission from the electric signal, an authentication code recording unit for nonvolatilely recording the authentication code, an encrypting unit for encrypting identification information peculiar to the radio transmission device with the authentication code used as a key, an identification information transmitting unit for transmitting the encrypted identification information peculiar to the radio transmission device, and an authentication unit for decrypting the received identification information peculiar to the radio transmission device of the opposite party of the transmission with the authentication code used as the key, and thereby obtaining the identification information peculiar to the radio transmission device of the opposite party.

Preferably, the remote control signal receiving unit receives the infrared signal indicating an arbitrary character string entered by a user with the remote control, converts the received infrared signal to the electric signal and extracts the arbitrary character string to obtain the authentication code.

Preferably, the remote control signal receiving unit receives the infrared signal emitted from the remote control, converts the received infrared signal to the electric signal and extracts a remote control signal waveform from the electric signal to obtain the authentication code.

According to another aspect of the invention, the invention provides a mutual authentication method of performing mutual authentication of opposite parties between first and second radio transmission devices performing radio transmission. The method includes the steps of causing each of the first and second radio transmission devices to receive an infrared signal emitted from a remote control, to convert the infrared signal to an electric signal and to extract an authentication code shared by the radio transmission devices performing the radio transmission from the electric signal; nonvolatilely storing the authentication code in each of the first and second radio transmission devices; causing the first radio transmission device to encrypt identification information peculiar to the first radio transmission device with the authentication code used as a key; causing the second radio transmission device to decrypt the received identification information peculiar to the first radio transmission device with the authentication code used as the key, and to obtain the identification information peculiar to the first radio transmission device; causing the second radio transmission device to encrypt identification information peculiar to the second radio transmission device with the authentication code used as a key, and to transmit the encrypted identification information to an address indicated by the identification information peculiar to the first radio transmission device; and causing the first radio transmission device to decrypt the received identification information peculiar to the second radio transmission device with the authentication code used as the key, and to obtain the identification information peculiar to the second radio transmission device.

Preferably, the step of extracting the authentication code includes the steps of entering an arbitrary character string shared by the first and second radio transmission devices into the remote control by the user; and causing each of the first and second radio transmission devices to receive the infrared signal emitted from the remote control and indicating the arbitrary character string, to convert the infrared signal to the electric signal and to obtain the authentication code by extracting the arbitrary character string.

Preferably, the step of extracting the authentication code includes the steps of entering an arbitrary single key shared by the first and second radio transmission devices into the remote control shared by the first and second radio transmission devices; and causing the first and second radio transmission devices to receive the infrared signal emitted from the remote control, to convert the infrared signal to the electric signal and to obtain the authentication code by extracting the remote control signal waveform from the electric signal.

According to another aspect of the invention, the invention provides a mutual authentication program of performing mutual authentication of opposite parties between first and second radio transmission devices performing radio transmission. The program causes a computer to execute the steps of causing each of the first and second radio transmission devices to receive an infrared signal emitted from a remote control, to convert the infrared signal to an electric signal and to extract an authentication code shared by the radio transmission devices performing the radio transmission from the electric signal; nonvolatilely storing the authentication code in each of the first and second radio transmission devices; causing the first radio transmission device to encrypt identification information peculiar to the first radio transmission device with the authentication code used as a key; causing the second radio transmission device to decrypt the received identification information peculiar to the first radio transmission device with the authentication code used as the key, and to obtain the identification information peculiar to the first radio transmission device; causing the second radio transmission device to encrypt identification information peculiar to the second radio transmission device with the authentication code used as a key, and to transmit the encrypted identification information to an address indicated by the identification information peculiar to the first radio transmission device; and causing the first radio transmission device to decrypt the received identification information peculiar to the second radio transmission device with the authentication code used as the key, and to obtain the identification information peculiar to the second radio transmission device.

Preferably, the step of extracting the authentication code includes the steps of entering an arbitrary character string shared by the first and second radio transmission devices into the remote control by the user; and causing each of the first and second radio transmission devices to receive the infrared signal emitted from the remote control and indicating the arbitrary character string, to convert the infrared signal to the electric signal and to obtain the authentication code by extracting the arbitrary character string.

Preferably, the step of extracting the authentication code includes the steps of entering an arbitrary single key shared by the first and second radio transmission devices into the remote control shared by the first and second radio transmission devices; and causing the first and second radio transmission devices to receive the infrared signal emitted from the remote control, to convert the infrared signal to the electric signal and to obtain the authentication code by extracting the remote control signal waveform from the electric signal.

According to the above aspect of the invention, it is possible to prevent misidentification and electrical interference due to another home or office in the mutual authentication operation by a simple structure, and high security can be ensured in the radio transmission system.

Further, various remote control signal waveforms can be used as the authentication codes so that each user can store the authentication code required for the mutual authentication only by depressing one key on the remote control. Therefore, the configuration can be further simplified while ensuring the security in the mutual authentication.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram illustrating a whole structure of a radio transmission device according to a first embodiment of the invention.

FIG. 2 schematically illustrates radio transmission of AV data between two radio transmission devices.

FIG. 3 schematically illustrates a principle of a mutual authentication method in the radio transmission device illustrated in FIG. 1.

FIG. 4 schematically illustrates an example of an authentication code recording operation according to the invention.

FIG. 5 is a flowchart illustrating an authentication code recording mode.

FIG. 6 is a flowchart illustrating an authentication communication mode.

FIG. 7 illustrates a sequence of mutual authentication performed between devices A and B in FIG. 5.

FIGS. 8A and 8B are signal waveform diagrams illustrating a form of a remote control signal.

FIGS. 9A-9D are remote control signal waveforms in typical four methods A-D, respectively.

FIG. 10 schematically illustrates another example of a manner of use of the radio transmission device according to the invention.

FIG. 11 schematically illustrates still another example of a manner of use of the radio transmission device according to the invention.

FIG. 12 schematically illustrates yet another example of a manner of use of the radio transmission device according to the invention.

FIG. 13 schematically shows an example of a manner of use of a radio transmission device.

FIG. 14 illustrates a configuration of a mutual authentication method disclosed in Japanese Patent Laying-Open No. 04-205453.

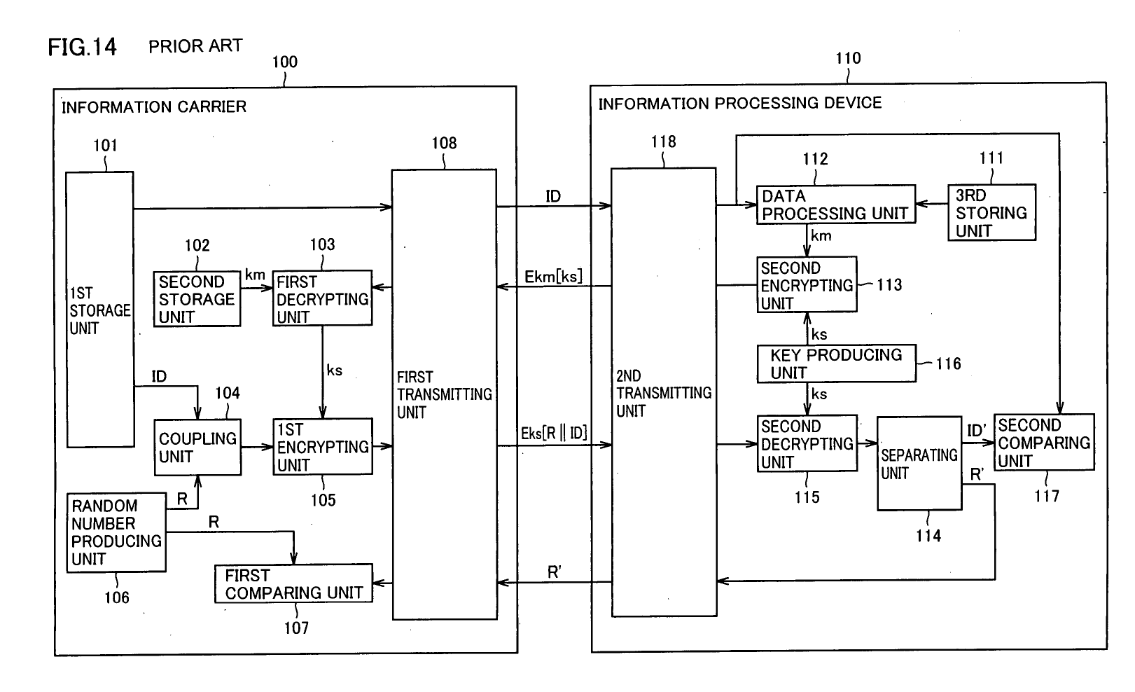

### DESCRIPTION OF THE PREFERRED EMBODIMENTS

Embodiments of the invention will now be described with reference to the drawings. In the following description, the same or corresponding portions bear the same reference numbers.

### First Embodiment

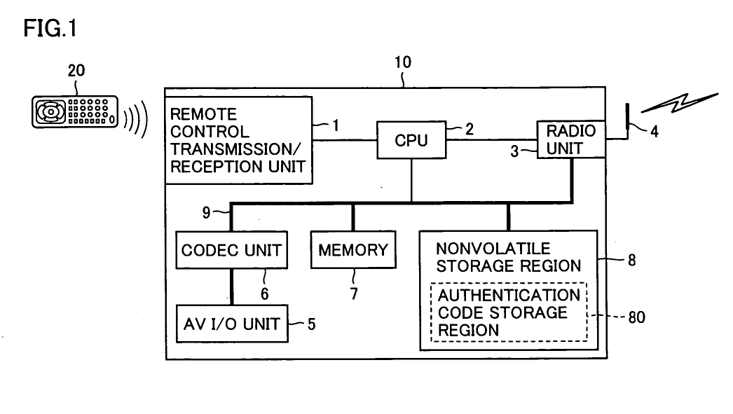

FIG. 1 is a functional block diagram illustrating a whole structure of a radio transmission device according to an embodiment of the invention. A radio transmission device transmitting AV data will now be described as an example of the radio transmission device in this embodiment.

Referring to FIG. 1, a radio transmission device 10 includes a remote control transmission/reception unit 1 for transmitting and receiving an infrared signal to and from a user's or another radio transmission device 10, and a CPU 2 controlling the whole device according to control information included in an electric signal, which is obtained by converting the received infrared signal, as well as a radio unit 3 and an antenna 4 for transmitting and receiving a radio signal to and from a radio transmission device (not shown) of an opposite party or side of the radio transmission.

Radio transmission device 10 further includes an AV input/output unit 5 for input/output of AV data, a codec unit 6 encoding or decoding the AV data, a memory 7 storing various programs and a nonvolatile storage region 8 nonvolatilely storing an authentication code, which will be described later.

Remote control transmission/reception unit 1 includes a remote control receiving unit 12 (not shown), which receives an infrared signal emitted from a remote control 20 by an operation of a user, and converts the received infrared signal to an electric signal, and a remote control transmitting unit 11 (not shown) converting the electric signal, which is control information transmitted from CPU 2, to an infrared signal, and transmitting it.

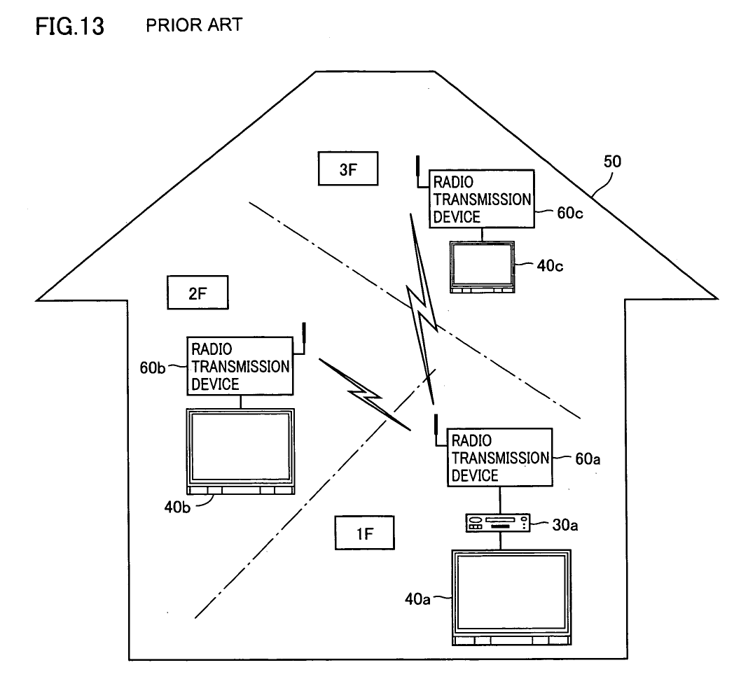

AV input/output unit 5 includes an AV data signal output terminal and an AV data signal input terminal (both not shown). In a manner of use, e.g., shown in FIG. 13, radio transmission device 10 is connected to each of AV data display devices 40b and 40c. In the case, the AV data signal output terminal (not shown) is connected to the AV data input terminal (not shown) of AV data display device 40b or 40c. Thereby, AV input/output unit 5 of radio transmission device 10 transfers the AV data, which is received from AV data reproducing device 30a via radio transmission devices 60a and 60b or radio transmission device 60a and 60c, to corresponding AV data display device 40b or 40c.

When radio transmission device 10 is connected to AV data reproducing device 30a in FIG. 13, the AV data signal input terminal (not shown) is coupled to the AV data signal output terminal (not shown) of AV data reproducing device 30a. Thereby, AV input/output unit 5 of radio transmission device 10 receives the AV data reproduced by AV data reproducing device 30a.

Nonvolatile storage region 8 includes an authentication code record region 80, on which the authentication code entered by the user via remote control 20 is recorded. Nonvolatile storage region 8 is formed of a nonvolatile memory such as such as a flash memory or an EEPROM (Electrically Erasable Programmable Read Only Memory), or another kind of hardware.

CPU 2 and the above portions are commonly connected to a bus 9. Bus 9 transmits control signals provided from CPU 2 as well as various signals such as AV data to be sent or received.

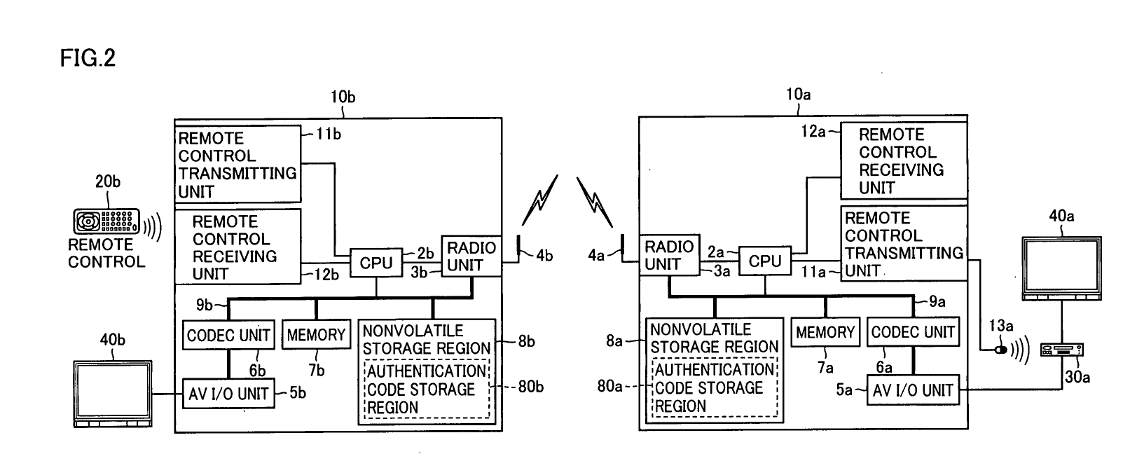

Description will now be given on the radio transmission of the AV data, which is performed by radio transmission device 10 shown in FIG. 1. FIG. 2 schematically illustrates the radio transmission of the AV data between two radio transmission devices (e.g., 10a and 10b).

Referring to FIG. 2, radio transmission device 10a has an AV input/output unit 5a connected to AV data display device 30a. Radio transmission device 10b has an AV input/output unit 5b connected to AV data reproducing device 40b.

A user, who intends to watch the AV data on desired AV data display device 40b, operates remote control 20b to emit an infrared signal, which serves as a control signal instructing reproduction of the AV data, to radio transmission device 10b connected to AV data display device 40b. A remote control receiving unit 12b of radio transmission device 10b receives this infrared signal, and converts it to an electric signal.

A CPU 2b analyzes and encodes the electric signal. The encoded electric signal is transferred to a radio unit 3b, which converts it to a radio signal serving as the control signal, and is transmitted from an antenna 4b. The radio signal is received by an antenna 4a of radio transmission device 10a connected to AV data reproducing device 30a.

In radio transmission device 10a connected to AV data reproducing device 30a, a radio unit 3a performs radio decoding on the radio signal received via antenna 4a, and further a CPU 2a decodes it to an electric signal of an infrared waveform. The decoded electric signal is provided from an infrared emission module 13a connected to a remote control transmitting unit 11a. When AV data reproducing device 30a receives the infrared signal by an internal remote control receiving unit (not shown), it recognizes the control signal formed of the infrared signal, and performs an operation instructed by the user.

AV data reproducing device 30a transmits the reproduced AV data to radio transmission device 10a connected thereto. Radio transmission device 10a receives the AV data by AV input/output unit 5a, and encodes the AV data by a codec unit 6a and a memory 7a under the control of CPU 2a. Radio unit 3a further converts the coded signal to a radio signal, which is transmitted from antenna 4a.

Finally, antenna 4b of radio transmission device 10b connected to AV data display device 40b receives the radio signal, and radio unit 3b performs the radio decoding on the signal previously encoded as described above. The signal subjected to the radio decoding is further decoded to the original AV data by a codec unit 6b and a memory 7b under the control of CPU 2b, and is transferred from AV input/output unit 5b to AV data display device 40b. AV data display device 40b displays images according to the image signal of the AV data, and also plays a sound according to the sound signal of the AV data.

As described above, since the radio transmission of the AV data and the infrared signal, i.e., the control signal is performed between the plurality of radio transmission devices, the user can remotely operate the AV data reproducing device to watch and listen to the movie and sound on the desired AV data display device.

For accurately performing the above operations without misidentification and electrical interference, the mutual authentication for mutually authenticating the opposite parties must be performed between the radio transmission devices executing the radio transmission as already described. Description will now be given on the mutual authentication method implemented between the radio transmission devices according to the embodiment.

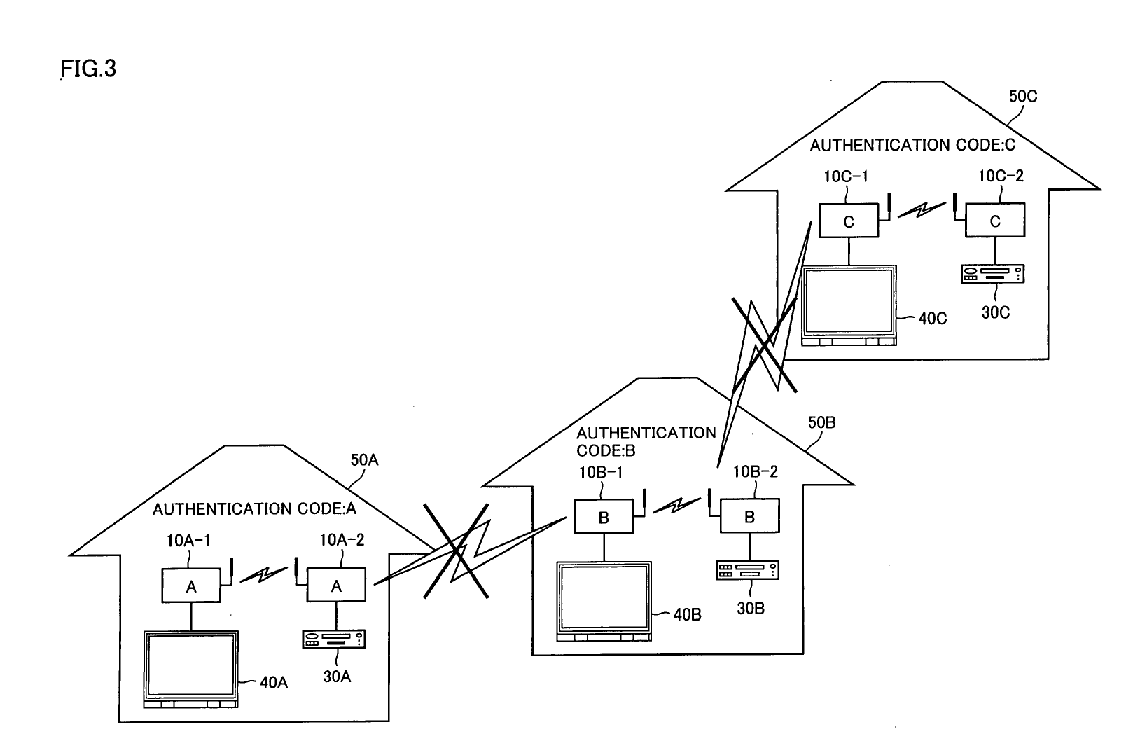

FIG. 3 schematically illustrates a principle of the mutual authentication method in the radio transmission devices illustrated in FIG. 1.

Referring to FIG. 3, AV data reproducing devices 30A-30C and AV data display devices 40A-40C are arranged in homes 50A-50C, respectively. Radio transmission devices 10A-1-10C-1 and 10A-2-10C-2 are connected to these devices 30A-30C and 40A-40C, respectively.

The authentication code, which is required for the mutual authentication and is set for each home, is different from those for the other homes. The authentication code is set during the authentication code record mode of the initial setting of each radio transmission device. For example, as illustrated in FIG. 2, an authentication code “A” is set for radio transmission devices 10A-1 and 10A-2 in home 50A. In home 50B, an authentication code “B” is set for radio transmission devices 10B-1 and 10B-2. In home 50C, an authentication code “C” is set for radio transmission devices 10C-1 and 10C-2.

When the authentication code record mode is completed, the operation enters the authentication communication mode for practically performing the mutual authentication. In the mutual communication mode, radio transmission device (e.g., radio transmission device 10A-2) transmits a radio unit MAC (Media Access Control) address, which is identification information peculiar to radio transmission device 10 itself, in a form encrypted with authentication code “A”. The radio unit MAC address is an address stationarily assigned to the radio unit of each device, and designates a destination of transmission of the data. It is a feature of this embodiment that the authentication code is used as the key for encrypting the radio unit MAC address.

The radio unit MAC address encrypted with authentication code “A” is transmitted without designating a destination address, and thus is transmitted to a so-called open address.

Each of radio transmission devices 10 receiving the radio unit MAC address attempts to decrypt it with the recorded authentication code used as the key. Naturally, only radio transmission device 10A-1 storing the same authentication code “A” as radio transmission device 10A-2 succeeds in decryption. Radio transmission device 10A-1 stores the decrypted radio unit MAC address as the address of the opposite party of the communication in nonvolatile storage region 8, and ends the authentication mode. In the subsequent normal communication mode, radio transmission device 10A-1 transmits the AV address to this address.

In radio transmission devices 10B-1, 10B-2, 10C-1 and 10C-2 in homes 50B and 50C having the different authentication codes, the radio unit MAC address cannot be decrypted correctly, and the authentication mode ends.

Specific manners of implementing the mutual authentication method in FIG. 3 will now be described.

The mutual authentication method according to the embodiment can be roughly divided into the authentication code record mode and the authentication communication mode. Each of these modes is executed prior to the start of the radio transmission, and is executed during the initial setting, which is performed, e.g., at the time of connection of radio transmission device 10.

In the authentication code record mode, the authentication code is recorded on authentication code record region 80 in each nonvolatile storage region 8 for sharing the authentication code by the plurality of radio transmission devices 10 performing the radio transmission. Recording of the authentication code is performed by entering an arbitrary code with remote control 20. This arbitrary code is formed of a string of multiple characters such as a combination of alphabets and numbers.

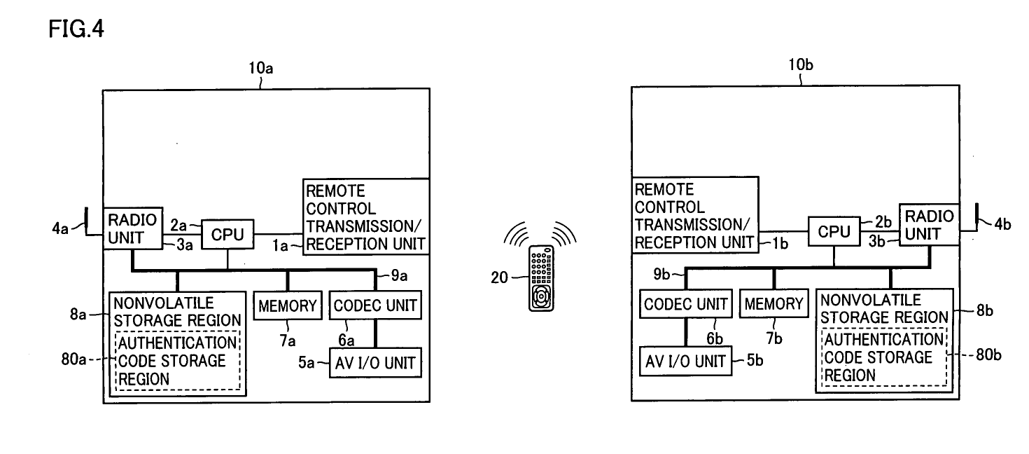

The user operates remote control 20 to emit the infrared signal formed of the same authentication code to each of the plurality of radio transmission devices 10 performing the radio transmission. For this operation, as illustrated in FIG. 4, such a configuration or manner may be employed that the user emits the infrared signal formed of the authentication code from remote control 20 while locating the plurality of radio transmission device 10 in positions neighboring to each other. Thereby, the recording of the authentication code can be completed by only one operation.

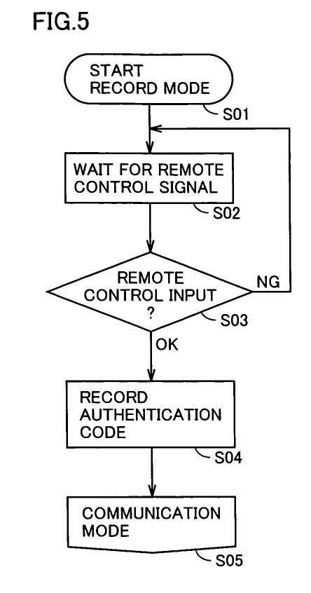

FIG. 5 is a flowchart illustrating the authentication code record mode.

As illustrated in FIG. 5, radio transmission device 10 is waiting for input of the authentication code during the initial setting state (step S02). When the user recognizes the input of the authentication code (step S03), the authentication code is recorded on authentication code record region 80 (step S04). After the recording, the authentication code record mode ends, and the authentication communication mode starts (step S05). The operation of recording the authentication code is completed by entering the same authentication code in radio transmission devices 10, between which the radio transmission is to be performed in the normal communication mode.

In the authentication communication mode, the mutual authentication is performed by encrypting the radio unit MAC address peculiar to each radio transmission device 10 with the recorded authentication code used as the key, and mutually transmitting the encrypted radio unit MAC addresses.

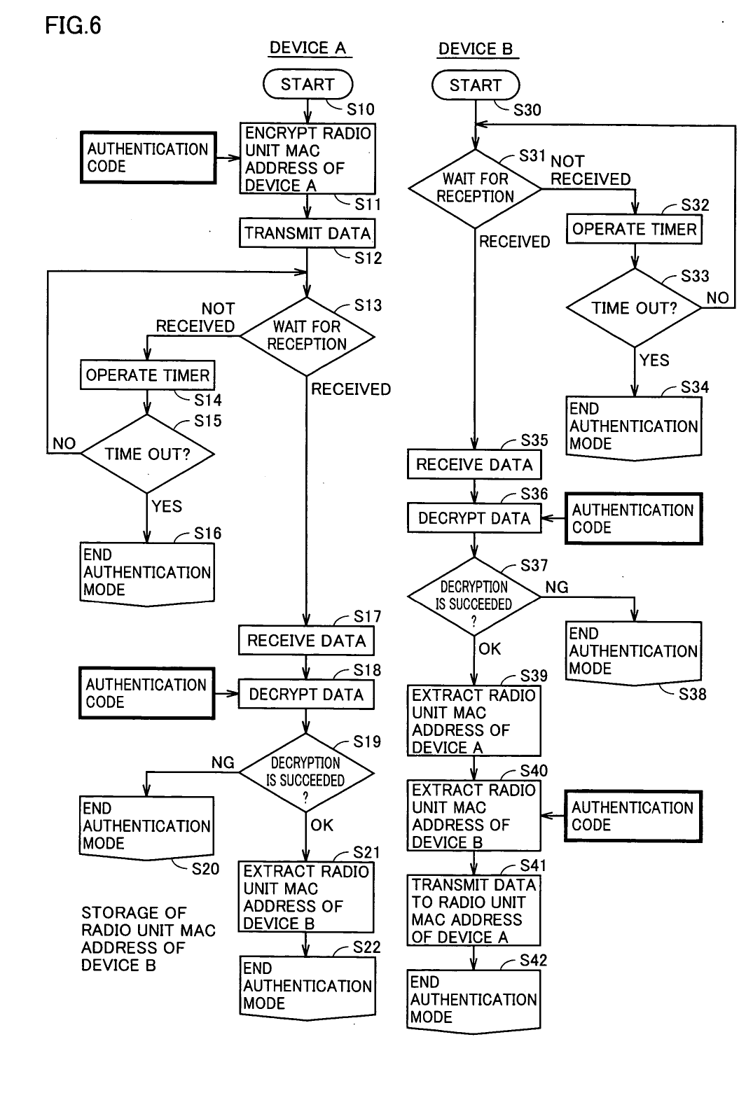

FIG. 6 is a flowchart for illustrating the authentication communication mode. The following description will be given on the mutual authentication between radio transmission devices 10 (which may also be referred to as “device A” or “device B” hereinafter) storing the same authentication code.

On the side of device A, the radio unit MAC address is first encrypted with the authentication code used as the key (step S11). The encrypted MAC address is transmitted to an open address, i.e., without designating the destination (step S12). After transmitting the radio unit MAC address, device A enters the state for waiting for a response (step S13).

Device A waits for the response in step S13, and at the same time, measures the time of waiting by a timer unit in CPU 2 (step S14). A predetermined waiting time is already preset in the timer unit, and the timer unit holds the state of waiting for the response until the preset time elapses (step S15). If the response is not received during the preset time, device A ends the authentication mode (step S16).

If the response is received during the preset time in step S13 (step S17), radio unit 3 in device A decrypts the received data with the key, which is formed of the authentication code recorded on authentication code record region 80 (step S18). When device A succeeds in the decryption, i.e., when device A confirms the response from device B having the same authentication code, device A stores the decrypted data in nonvolatile storage region 8 while handing the radio unit MAC address of device B thus obtained as the address of the destination (step S21).

When device A fails the decryption in step S19, i.e., when mismatching occurs between authentication codes of device A and the device of the origin or sender side, device A does not authenticate the device on the origin side, and ends the authentication mode (step S20).

In contrast to this, device B is in the state of waiting for reception of the radio unit MAC address from radio transmission device 10 of the opposite party of the transmission (step S31). In this state, device B likewise measures the waiting time by the timer unit, similarly to device A (step S32). Device B holds the waiting state during a waiting time, which is preset in the timer unit. When the measured time exceeds the preset waiting time (step S33), device B ends the authentication mode (step S34).

When device B receives the data transmitted from radio transmission device 10 within the preset time in step S31 (step S35), radio unit 3 of device B decrypts the transmitted data with the key, which is formed of the authentication code recorded on authentication code record region 80 (step S36). When device B succeeds in the decryption, i.e., when device B confirms the response from device A having the same authentication code, device B stores the decrypted data in nonvolatile storage region 8 while handing the radio unit MAC address of device A thus extracted as the address of the destination (step S39).

When device B fails the decryption in step S37, i.e., when mismatching occurs between authentication codes of device B and the device on the origin or sender side (step S40), device B does not authenticate the device on the origin side, and ends the authentication mode (step S38).

Device B encrypts its own radio unit MAC address with the key formed of the authentication code, which is recorded on authentication code record region 80 (step S40), and transmits it to the radio unit MAC address of device A extracted in step S39 (step S41). Thereby, the authentication mode ends. The data transmitted from device B is received by device A, which is in the waiting state in foregoing step S13.

After devices A and B confirm the opposite parties of the communication to end the authentication mode, respectively, the radio transmission of the AV data is then executed between devices A and B in the normal operation mode.

The mutual authentication between devices A and B is practically executed by software running on CPUs 2 in radio transmission devices 10 in accordance with flowcharts of FIGS. 5 and 6. The CPUs 2 read programs, which include the steps in the flowcharts of FIGS. 5 and 6, from memories 7, and execute the read programs. Therefore, memory 7 corresponding to a computer-readable record medium bearing the programs, which include the steps in the authentication mode illustrated in FIGS. 5 and 6.

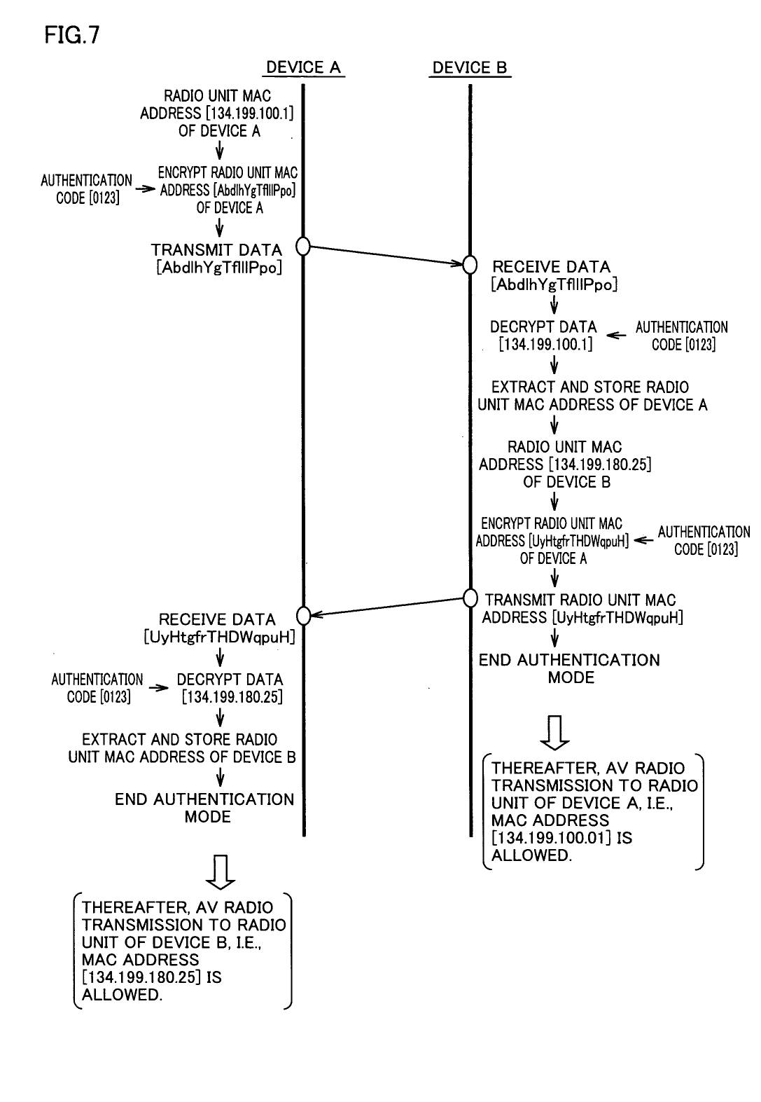

FIG. 7 illustrates a mutual authentication sequence executed between devices A and B in FIG. 6.

Referring to FIG. 7, device A is assigned the radio unit MAC address, e.g., of [134.199.100.1] peculiar to it. Further, an authentication code (e.g., [0123]), which can be shared by, i.e., can be commonly available in the plurality of radio transmission devices performing the radio transmission, is recorded on authentication code record region 80 in device A.

In the authentication communication mode, radio unit 3 in device A transmits the data (e.g., [AbdlhYgTflllPpo]), which is produced by encrypting its own radio unit MAC address with the authentication code [0123] used as the key.

Radio unit 3 of device B receives the data transmitted from device A, and decrypts the received data with the key formed of the authentication code recorded on authentication code record region 80 in device B. In this operation, devices A and B have stored the same authentication code [0123], which was recorded in the authentication code record mode, so that data [134.199.100.1] decrypted with this authentication code is obtained. Naturally, the decrypted address matches with the radio unit MAC address of device A. Device B authenticates device A as the opposite party of the transmission, and stores the decrypted data as the radio unit MAC address of device A in nonvolatile storage region 8.

Subsequently, for causing device A to authenticate device B, device B encrypts the radio unit MAC address (e.g., [134.199.180.25]) of device B with the authentication code of [0123] used as the key, and transmits the encrypted data (e.g., [UyHtgfrTHDWqpuH]) to the radio unit MAC address of device A. After the transmission, device B ends the authentication mode.

Radio unit 3 in device A receives the data transmitted from device B, and decrypts the received data with the authentication code of [0123] used as the key. Decrypted data [134.199.180.25] is extracted as the radio unit MAC address of device B, and is stored in nonvolatile storage region 8. Device A authenticates device B as the radio transmission device, and ends the authentication mode.

When devices A and B complete the authentication mode, the subsequent radio transmission is performed with the destination indicated by the stored radio unit MAC address of the opposite party.

According to the first embodiment of the invention, as described above, the misidentification and electrical interference due to another home or office can be avoided in the authentication operation by the simple structure, and high security can be ensured in the radio transmission system.

### Second Embodiment

In the foregoing embodiment, the authentication code shared by radio transmission devices 10 performing the radio transmission is designated and recorded by the user entering the arbitrary character string via remote control 20 in the authentication code record mode. In this operation, the infrared signal of the authentication code emitted from remote control 20 is converted to the electric signal by remote control receiving unit 12 in remote control transmission/reception unit 1 in FIG. 1, and the authentication code is obtained by decoding the electric signal thus obtained, and is transferred to authentication code record region 80.

The electric signal, which is produced by remote control receiving unit 12, and will be referred to as a “remote control signal” hereinafter, is formed of a pulse signal string. Remote control receiving unit 12 samples the level of the remote control signal with a period of a fraction of a minimum pulse width, and extracts a remote control instruction code, which is control information.

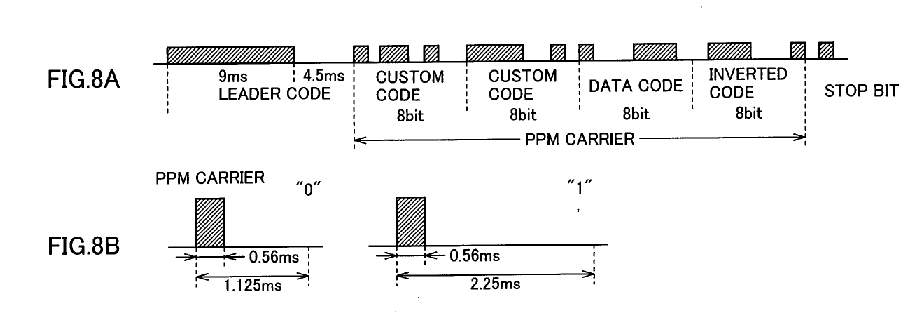

FIGS. 8A and 8B are signal waveform diagrams illustrating a form of the remote control signal.

Referring to FIG. 8A, the remote control signal waveform has a period of “H”, which starts in response to depression of one key on remote control 20, and has a length of 9 ms. This period of “H” is followed by a period of “L” having a length of 4.5 ms. The portion including these periods is referred to as a leader code, and represents input of the remote control signal.

The leader code is followed by a signal of 16 bits, which is referred to as a custom code. The signal of 16 bits is formed of a first half of 8 bits and a second half of 8 bits, which are reversed with respect to each other.

After the custom bits, a data code of 8 bits and an inverted code of the data code of 8 bits are transmitted. The data code forms the remote control instruction code entered by the user. After the data code, a stop bit indicating the end of the remote control signal is transmitted.

As described above, when the user depresses one key on remote control 20, the electric signal of 32 bits illustrated in FIG. 8A is transmitted in response to the depression.

The remote control signal employs a PPM (Pulse Position Modulation) method, in which binary bits “0” and “1” are represented by differences in pulse interval. For example, as illustrated in FIG. 8B, “0” and “1” are represented depending on the difference in length of the period of “L” with respect to that of “H” of 0.56 ms. The custom code and data code of the remote control signal in FIG. 8A are formed of “0” and “1” represented in the PPM method.

Instead of the method in FIG. 8B, the binary bits can be expressed in a method utilizing differences in length of the period of “H”. Further, in connection with this length of the period of “H”, various methods have been employed depending on types of control target devices and manufacturers.

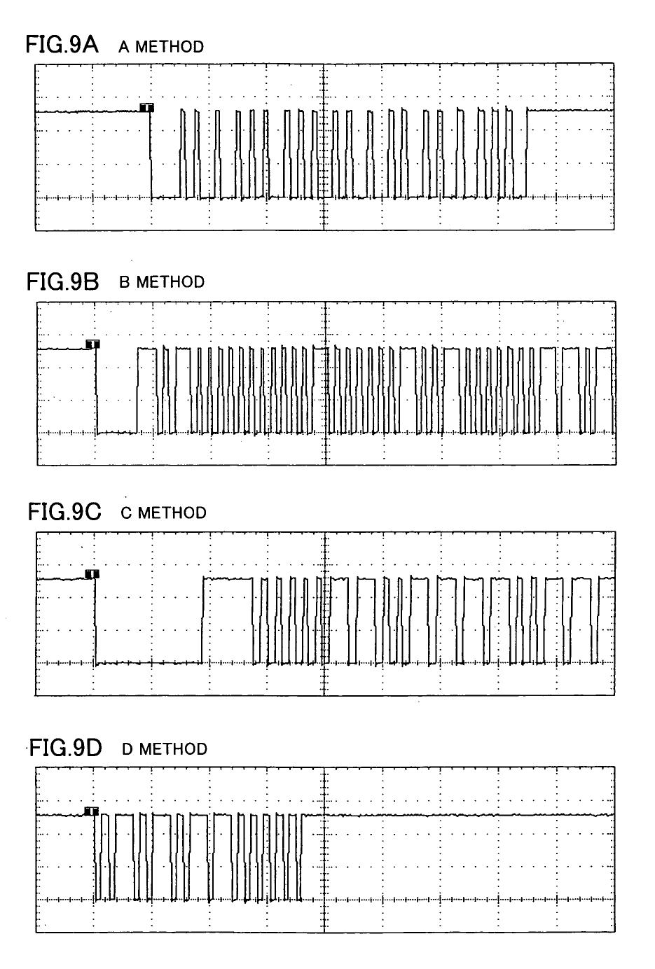

FIGS. 9A-9D illustrate remote control signal waveforms in typical four methods A-D, respectively.

Referring to FIGS. 9A-9D, the methods A-D have respective features. For example, in connection with the leader code in the leading position, each of methods A-C employs the leader code, and the method D does not employ the leader code. Further, the leader codes in the former methods have different lengths, respectively. In connection with the custom code and data code, the different methods employ different pulse widths and/or different bit numbers, respectively.

In view of the fact that different signal methods are employed depending on the manufacturers and types of control target devices, it is proposed in this embodiment to use various remote control signal waveforms as the authentication codes in the mutual authentication between radio transmission devices. According to this, the user can record the authentication code required for the mutual authentication by a simple operation of depressing one of the keys on remote control 20.

More specifically, in the authentication code record mode of the first embodiment already described with reference to FIG. 5, the user does not enter the authentication code formed of a character string of a plurality of characters, and alternatively the user depresses one key on remote control 20. The infrared signal emitted from remote control 20 is converted by remote control receiving unit 12 of radio transmission device 10 to an electric signal having a signal waveform illustrated in FIGS. 9A-9D. Since this electric signal has the signal waveform, which varies variously depending on the manufacturer and the control target device, a specific signal waveform can be shared as the authentication code by radio transmission devices 10 when each of the users of radio transmission devices 10 depresses the same key of the same remote control 20. Thereby, the mutual authentication can be performed.

The authentication communication mode is substantially the same as that of the first embodiment already described with reference to FIG. 6. Thus, each of radio transmission devices 10 authenticates the opposite party by transmitting its own radio unit MAC address, which is encrypted with the key formed of the remote control signal waveform illustrated in one of FIG. 9A-9D, to the other party.

According to the second embodiment of the invention, various remote control signal waveforms are utilized as the authentication codes, and thereby the user can store the authentication code required for the mutual authentication by depressing one key on the remote control so that further simplification can be achieved while ensuring the security in the mutual authentication.

### Third Embodiment

According to the invention, the radio transmission device can perform the radio transmission of the data signal with high security by performing the mutual authentication already described in connection with the first and second embodiments. The data signal, which is transmitted by radio, may include a program signal for controlling a home electric appliance or a computer connected to the radio transmission device, in addition to the AV data already described. Third to fifth embodiments will now be described in connection with forms of use of the radio transmission device of the invention in the radio transmission systems.

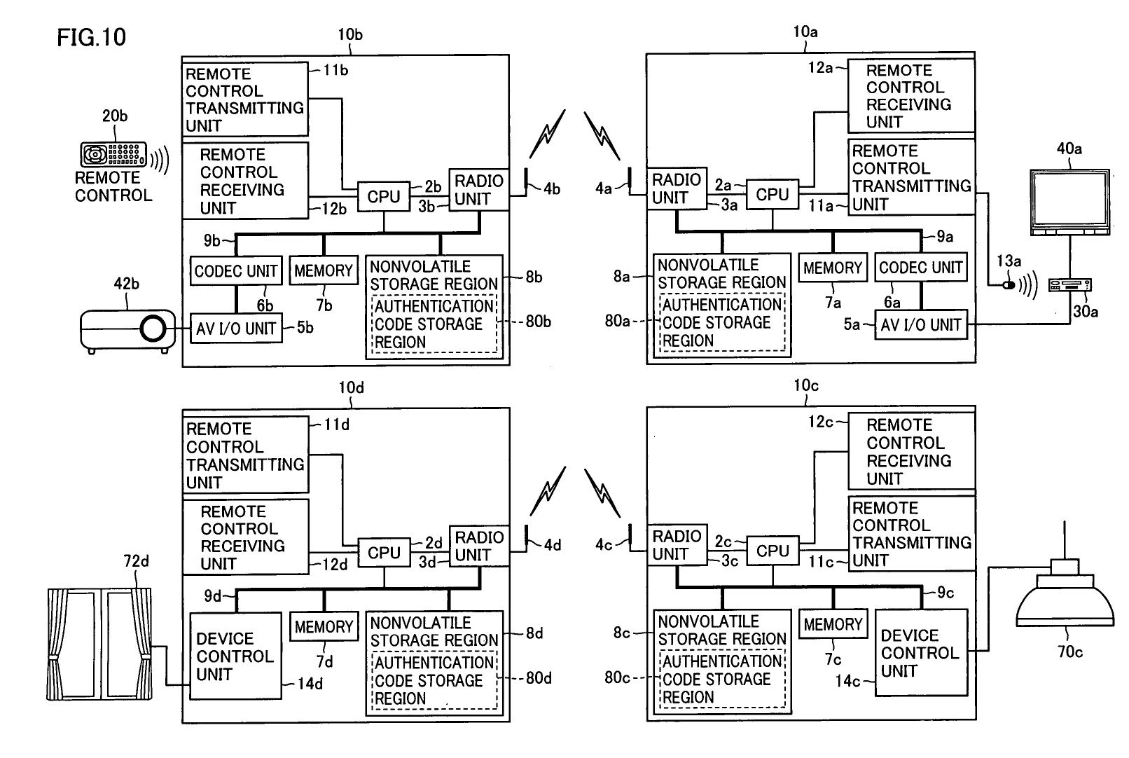

FIG. 10 schematically illustrates another example of a manner of use of a radio transmission device according to the invention.

Referring to FIG. 10, AV data display device 40a (e.g., television set) and AV data reproducing device 30a (e.g., DVD player) connected to AV data display device 40a are arranged in the home. In a room of the home, an AV data display device 42b (e.g., projector), an illuminator 70c and a motor-operated curtain 72d.

AV data reproducing device 30a, AV data display device 42b, illuminator 70c and motor-operated curtain 72d are connected to radio transmission devices 10a-10d, respectively. Among these radio transmission devices 10a-10d, radio transmission devices 10a and 10b have the same structure as those in FIG. 2. Radio transmission devices 10c and 10d differ from those illustrated in FIG. 2 in that AV input/output unit 5a (or 5b) and codec unit 6a (or 6b) in FIG. 2 are replaced with device control units 14c and 14d controlling illuminator 70c and motor-operated curtain 72d connected to thereto, respectively.

In the above structure, radio transmission devices 10a-10d execute the mutual authentication according to the method already described in connection with the first or second embodiment prior to the execution of the radio transmission of the data signal. More specifically, the user records the same authentication code on authentication code record regions 80a-80d of radio transmission devices 10a-10d in the authentication code record mode of the initial setting. In the authentication communication mode, the mutual authentication is performed by encrypting the radio unit MAC addresses peculiar to radio transmission devices 10a-10d with the recorded authentication code used as the key, and mutually transmitting them.

When the normal communication mode starts after the completion of the authentication mode, the user, who intends to watch the AV data on desired AV data display device 42b, operates remote control 20b to emit the infrared signal forming the control signal, which instructs reproduction of the AV data, to radio transmission device 10b connected to AV data display device 42b. Similarly to the operation illustrated in FIG. 2, the infrared signal is output from antenna 4b after being converted to the radio signal, and is received by radio transmission device 10a. Radio transmission device 10a converts the radio signal to the infrared signal, and emits it from infrared emission module 13a. When AV data reproducing device 30a receives the infrared signal, it recognizes the control signal formed of the infrared signal, and reproduces the AV data according to the control signal.

The AV data reproduced by AV data reproducing device 30a is converted by radio transmission device 10a to the radio signal, and is transmitted to radio transmission devices 10b-10d.

Radio transmission devices 10b-10d receive the radio signal thus transmitted. Radio transmission device 10b decrypts the received radio signal to produce the original AV data via codec unit 6b and memory 7b, and transfers it from AV input/output unit 5b to AV data display device 42b. Thereby, AV data display device 42b reproduces the movie and sound according to the AV data.

When radio transmission device 10c receives the radio signal, a CPU 2c in radio transmission device 10c provides the control signal, which instructs lowering of illuminance in the room, to device control unit 14c. Device control unit 14c receiving the control signal lowers the illuminance of illuminator 70c, or turns off illuminator 70c so that illuminator 70c is controlled to attain the instructed illuminance in the room.

When radio transmission device 10d receives the radio signal, a CPU 2d in radio transmission device 10d provides the control signal, which instructs a closing operation of motor-operated curtain 72d, to device control unit 14d. Device control unit 14d receiving the control signal controls motor-operated curtain 72d to perform the closing operation.

Owing to the above structure, radio transmission devices 10b and 10c receiving the radio signal operate to reproduce the AV data on AV data display device 42b and to lower the illuminance in the room, respectively. Consequently, by only one operation of remote control 20b for AV data display device 42b, the user can reproduce the AV data, and can also prepare an environment suitable for watching the AV data.

In FIG. 10, radio transmission devices 10a-10d are connected to AV data reproducing device 30a, AV data display device 42b, illuminator 70c and motor-operated curtain 72d, respectively. However, radio transmission devices 10a-10d may be arranged within the corresponding devices, respectively. In this case, AV input/output units 5a and 5b as well as codec units 6a and 6b, which are included in radio transmission devices 10a and 10b, are shared with corresponding units included in AV data reproducing device 30a and AV data display device 42b, respectively. Device control units 14c and 14d included in radio transmission devices 10c and 10d are shared with control units (not shown) included in illuminator 70c and motor-operated curtain 72d.

### Fourth Embodiment

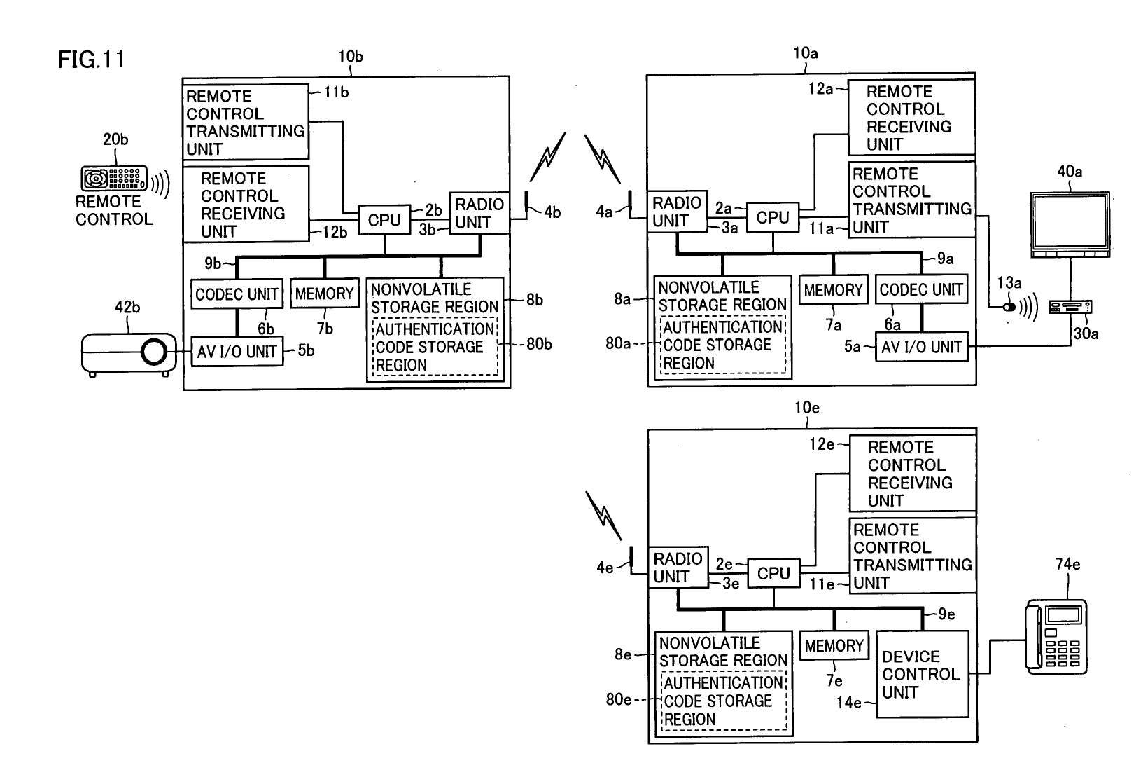

FIG. 11 schematically illustrates still another example of a manner of use of a radio transmission device according to the invention.

Referring to FIG. 11, AV data display device 40a (e.g., television set) and AV data reproducing device 30a (e.g., DVD player) connected to AV data display device 40a are arranged in a home. Also, AV data display device 42b (e.g., projector) and a communication device (e.g., a telephone 74e) are arranged in the home.

AV data reproducing device 30a, AV data display device 42b and telephone 74e are connected to radio transmission devices 10a, 10b and 10e. Among these radio transmission devices 10a, 10b and 10e, radio transmission devices 10a and 10b have the same structure as radio transmission devices 10a and 10b in FIG. 10. Radio transmission device 10e differs from radio transmission devices 10a or 10b in that AV input/output unit 5a (or 5b) and codec unit 6a (or 6b) are replaced with a device control unit 14e controlling telephone 72e connected thereto.

In the above structure, radio transmission devices 10a, 10b and 10e execute the mutual authentication according to the method already described in connection with the first or second embodiment prior to the execution of the radio transmission of the data signal. More specifically, each of radio transmission devices 10a, 10b and 10e performs the mutual authentication by encrypting its own radio unit MAC addresses with the key formed of the same authentication code recorded on authentication code record regions 80a, 80b or 80e, and mutually transmitting them.

When the normal communication mode starts after the completion of the authentication mode, the user, who intends to watch the AV data on desired AV data display device 42b, operates remote control 20b to emit the infrared signal forming the control signal, which instructs reproduction of the AV data, to radio transmission device 10b connected to AV data display device 42b. Similarly to the operation illustrated in FIG. 10, the infrared signal is output from antenna 4b after being converted to the radio signal, and is received by radio transmission device 10a. Radio transmission device 10a converts the radio signal to the infrared signal, and emits it from infrared emission module 13a. When AV data reproducing device 30a receives the infrared signal, it recognizes the control signal formed of the infrared signal, and reproduces the AV data according to the control signal.

The AV data reproduced by AV data reproducing device 30a is converted by radio transmission device 10a to the radio signal, and is transmitted to radio transmission devices 10b and 10e.

Radio transmission device 10b receiving the radio signal decrypts it to produce the original AV data via codec unit 6b and memory 7b, and transfers it from AV input/output unit 5b to AV data display device 42b. Thereby, AV data display device 42b reproduces the movie and sound according to the AV data.

When radio transmission device 10e receives the radio signal, a CPU 2e in radio transmission device 10e provides the control signal, which instructs change in setting of a unit indicating an incoming call, to device control unit 14e. Device control unit 14e receiving the control signal controls telephone 74e to lower a volume of a ringing tone, or to change a mode of indicating the incoming call by a ringing sound to a mode of indicating it by turning on a button light or the like.

Owing to the above structure, radio transmission devices 10b and 10e receiving the radio signal operate to reproduce the AV data on AV data display device 42b and to prevent a sound of telephone 74e from disturbing the watching. Consequently, by only one operation of remote control 20b for AV data display device 42b, the user can reproduce the AV data, and can also prepare an environment suitable for watching the AV data.

### Fifth Embodiment

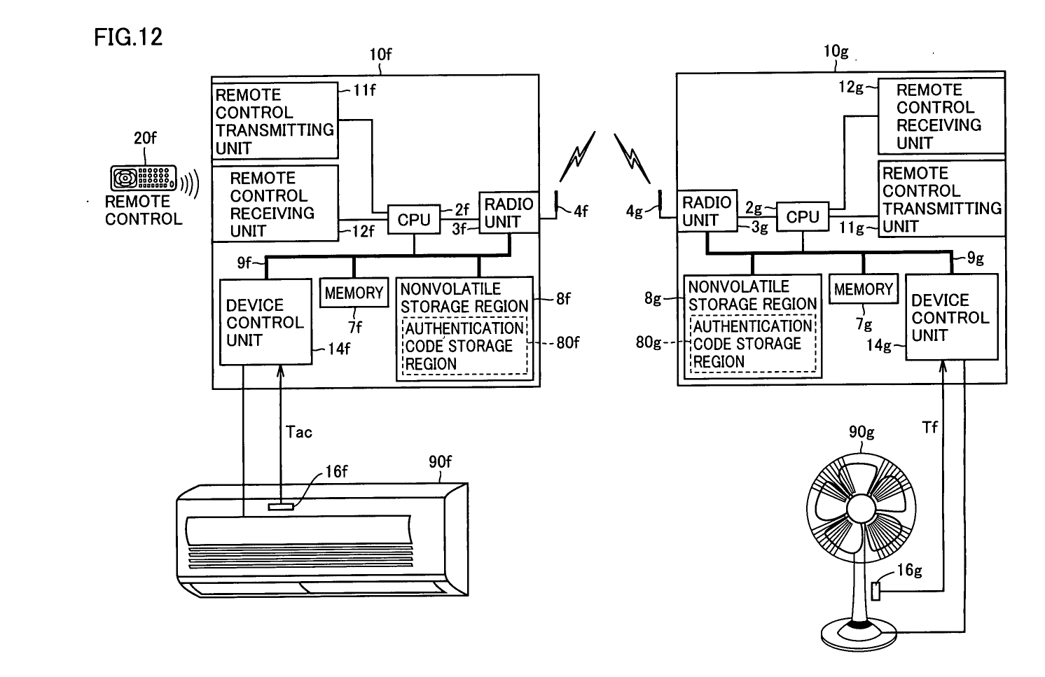

FIG. 12 schematically illustrates yet another example of a manner of use of a radio transmission device according to the invention.

Referring to FIG. 12, an air conditioning device 90f (e.g., an air conditioner) and an air conditioning device 90g (e.g., an electric fun) are arranged in a home.

Air conditioning devices 90f and 90g are connected to radio transmission devices 10f and 10g, respectively. Each of radio transmission devices 10f and 10g differs from radio transmission device 10a in FIG. 10 in that AV input/output unit 5a and codec unit 6a are replaced with a device control unit 14f or 14g for controlling air conditioning device 90f or 90g connected thereto.

As illustrated in FIG. 12, device control units 14f and 14g are connected to temperature sensors 16f and 16g attached to air conditioning devices 90f and 90g, respectively. Each of temperature sensors 16f and 16g detects an ambient temperature of air conditioning device 90f or 90g, and provides the detected temperature to device control unit 14f or 14g. When device control unit 14f receives an ambient temperature Tac of air conditioning device 90f from temperature sensor 16f, and provides detected temperature Tac to a CPU 2f When device control unit 14g receives an ambient temperature Tf of air conditioning device 90g from temperature sensor 16g, it provides temperature Tf to a CPU 2g.

In the above structure, radio transmission devices 10f and 10g execute the mutual authentication according to the method already described in connection with the first or second embodiment prior to the execution of the radio transmission of the data signal. More specifically, each of radio transmission devices 10f and 10g performs the mutual authentication by encrypting its own radio unit MAC addresses with the key formed of the same authentication code recorded on an authentication code record region 80g or 80f, and mutually transmitting them.

When the normal communication mode starts after the completion of the authentication mode, the user operates a remote control 20f to emit the infrared signal forming the control signal, which instructed the operation of air conditioning device 90f, to radio transmission device 10f connected to air conditioning device 90f. The emitted infrared signal is converted to the radio signal via CPU 2f and a radio unit 3f, and is output from an antenna 4f Further, CPU 2f converts temperature Tac received from device control unit 14f to the radio signal via radio unit 3f.

Radio transmission device 10g receives the control signal and temperature Tac converted into the radio signals. When radio transmission device 10g receives the radio signal, CPU 2g detects a difference between temperature Tac included in the radio signal and temperature Tf received from device control unit 14g. Based on the detected temperature difference, CPU 2g determines whether the air conditioning device is to be operated or not. When the temperature difference is equal to or larger than a predetermined value, CPU 2g provides a control signal operating air conditioning device 90g to device control unit 14g. Device control unit 14g operates air conditioning device 90g according to the control signal. Thereby, air conditioning device 90g ventilates a room to keep a uniform temperature. When the temperature difference becomes lower than the predetermined value, CPU 2g provides the control signal stopping air conditioning device 90g to device control unit 14g. Device control unit 14g stops air conditioning device 90g according to the control signal.

According to the above structure, radio transmission device 10g receiving the radio signal automatically operates or stops air conditioning device 90g. Consequently, by only one operation of remote control 20f for air conditioning device 90g, the user can produce a comfortable environment.

Although the present invention has been described and illustrated in detail, it is clearly understood that the same is by way of illustration and example only and is not to be taken by way of limitation, the spirit and scope of the present invention being limited only by the terms of the appended claims.

1. A radio transmission device for transmitting a data signal by radio, comprising:
mutual authentication means for performing mutual authentication of opposite parties between said radio transmission devices performing radio transmission; and
radio transmitting means for transmitting said data signal by radio between the authenticated radio transmission devices, wherein
said mutual authentication means includes:
remote control signal receiving means for receiving an infrared signal emitted from a remote control, converting said infrared signal to an electric signal and extracting an authentication code shared by said radio transmission devices performing the radio transmission from said electric signal,
authentication code recording means for nonvolatilely recording said authentication code,
encrypting means for encrypting identification information peculiar to said radio transmission device with said authentication code used as a key,
identification information transmitting means for transmitting the encrypted identification information peculiar to said radio transmission device, and
authentication means for decrypting the received identification information peculiar to the radio transmission device of said opposite party of the transmission with said authentication code used as the key, and thereby obtaining the identification information peculiar to the radio transmission device of said opposite party.

2. The radio transmission device according to claim 1, wherein
said remote control signal receiving means receives said infrared signal indicating an arbitrary character string entered by a user with said remote control, converts the received infrared signal to said electric signal and extracts said arbitrary character string to obtain said authentication code.

3. The radio transmission device according to claim 1, wherein
said remote control signal receiving means receives said infrared signal emitted from said remote control, converts the received infrared signal to said electric signal and extracts a remote control signal waveform from said electric signal to obtain said authentication code.

4. A mutual authentication method of performing mutual authentication of opposite parties between first and second radio transmission devices performing radio transmission, comprising the steps of:
causing each of said first and second radio transmission devices to receive an infrared signal emitted from a remote control, to convert said infrared signal to an electric signal and to extract an authentication code shared by said radio transmission devices performing the radio transmission from said electric signal;
nonvolatilely storing said authentication code in each of said first and second radio transmission devices;
causing said first radio transmission device to encrypt identification information peculiar to said first radio transmission device with said authentication code used as a key;
causing said second radio transmission device to decrypt the received identification information peculiar to said first radio transmission device with said authentication code used as the key, and to obtain the identification information peculiar to said first radio transmission device;
causing said second radio transmission device to encrypt identification information peculiar to said second radio transmission device with said authentication code used as a key, and to transmit the encrypted identification information to an address indicated by the identification information peculiar to said first radio transmission device; and
causing said first radio transmission device to decrypt the received identification information peculiar to said second radio transmission device with said authentication code used as the key, and to obtain the identification information peculiar to said second radio transmission device.

5. The mutual authentication method according to claim 4, wherein
said step of extracting said authentication code includes the steps of:
entering an arbitrary character string shared by said first and second radio transmission devices into said remote control by the user; and
causing each of said first and second radio transmission devices to receive the infrared signal emitted from said remote control and indicating the arbitrary character string, to convert said infrared signal to said electric signal and to obtain the authentication code by extracting the arbitrary character string.

6. The mutual authentication method according to claim 4, wherein
said step of extracting said authentication code includes the steps of:
entering an arbitrary single key shared by said first and second radio transmission devices into said remote control shared by said first and second radio transmission devices; and
causing said first and second radio transmission devices to receive said infrared signal emitted from said remote control, to convert said infrared signal to said electric signal and to obtain said authentication code by extracting the remote control signal waveform from said electric signal.

7. A mutual authentication program of performing mutual authentication of opposite parties between first and second radio transmission devices performing radio transmission, said program causing a computer to execute the steps of:
causing each of said first and second radio transmission devices to receive an infrared signal emitted from a remote control, to convert said infrared signal to an electric signal and to extract an authentication code shared by said radio transmission devices performing the radio transmission from said electric signal;
nonvolatilely storing said authentication code in each of said first and second radio transmission devices;
causing said first radio transmission device to encrypt identification information peculiar to said first radio transmission device with said authentication code used as a key;
causing said second radio transmission device to decrypt the received identification information peculiar to said first radio transmission device with said authentication code used as the key, and to obtain the identification information peculiar to said first radio transmission device;
causing said second radio transmission device to encrypt identification information peculiar to said second radio transmission device with said authentication code used as a key, and to transmit the encrypted identification information to an address indicated by the identification information peculiar to said first radio transmission device; and
causing said first radio transmission device to decrypt the received identification information peculiar to said second radio transmission device with said authentication code used as the key, and to obtain the identification information peculiar to said second radio transmission device.

8. The mutual authentication method according to claim 7, wherein
said step of extracting said authentication code includes the steps of:
entering an arbitrary character string shared by said first and second radio transmission devices into said remote control by the user; and
causing each of said first and second radio transmission devices to receive the infrared signal emitted from said remote control and indicating the arbitrary character string, to convert said infrared signal to said electric signal and to obtain the authentication code by extracting the arbitrary character string.

9. The mutual authentication method according to claim 7, wherein
said step of extracting said authentication code includes the steps of:
entering an arbitrary single key shared by said first and second radio transmission devices into said remote control shared by said first and second radio transmission devices; and
causing said first and second radio transmission devices to receive said infrared signal emitted from said remote control, to convert said infrared signal to said electric signal and to obtain said authentication code by extracting the remote control signal waveform from said electric signal.
